(19) United States
(12) Patent Application Publication
(10) Pub. No.: US 2013/0240157 A1
(43) Pub. Date: Sep. 19, 2013

(54) ELECTRIC WINDOW BLINDS

(71) Applicants: HAO-TING CHEOU, TAINAN CITY (TW); YAO-CHING HUANG, TAINAN CITY (TW)

(72) Inventors: HAO-TING CHEOU, TAINAN CITY (TW); YAO-CHING HUANG, TAINAN CITY (TW)

(73) Assignee: OMA AUTOMATION ENTERPRISE CO., LTD., TAINAN CITY (TW)

(21) Appl. No.: 13/422,032

(22) Filed: Mar. 16, 2012

(51) Int. Cl. E06B 9/322

(52) U.S. Cl. 160/168.1 P

(57) ABSTRACT

An electric window blind includes a window frame and multiple slats are located between two side rails of the window frame. Each of the slats has two end faces and each end face has a mediate portion and two end portions. The medial portion of each of two end faces of each of the slats is pivotably connected to the window frame. An adjustment device has a power unit which has an output end and an arm with an elongate slot is connected to the output end. A link is fixed to the plates and has a protrusion which is movably engaged with the elongate slot. One of the two end portions of each slat is pivotably connected to the plate. By activating the power unit, the slats are pivoted to adjust the angular positions of the slats.

### BACKGROUND OF THE INVENTION

1. Field of the Invention

The present invention relates to a window blind, and more particularly, to an electric window blind wherein the angles of the slats are adjusted by an electric adjustment device.

2. Description of Related Art

Windows provide ventilation to bring fresh air into the room and light is also introduced into the room to have better illumination. However, windows also make the activities in the room be visible from outside so that window blinds are used to close the windows when needed. The conventional window blinds such as shutters, roller blinds and roman shades, all of which are designed to set an adjustable barrier between the interior and the exterior of the room and the users can operate the window blinds to be partially or completely opened or closed.

For the windows with slats, the slats are connected by ropes which are connected with a control device located in the head box and the uses can operate the rope to lift the slats upward or downward. The slats can also be controlled to be pivoted and set at different angular positions by a control bar to introduce light into the room or to shut the window blind off.

The pivotal movements of the slats of the window blinds are operated by pull the rope or rotate a control bar and this means that the users have to approach the window to access the rope and the control bar. This may not be convenient for some users.

The present invention intends to provide an electric window blind and the slats are pivoted by the electric motor to be effectively operated.

### SUMMARY OF THE INVENTION

The present invention relates to an electric window blind and comprises a window frame and multiple slats which are located between two side rails of the window frame. Each of the slats has two end faces and each end face has a mediate portion and two end portions. The medial portion of each of two end faces of each of the slats is pivotably connected to the window frame. An adjustment device has a power unit which has an output end and an arm with an elongate slot is connected to the output end. A link is fixed to the plates and has a protrusion which is movably engaged with the elongate slot. One of the two end portions of each slat is pivotably connected to the plate. By activating the power unit, the slats are pivoted to adjust the angular positions of the slats.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the window blind of the present invention;

FIG. 2 is another perspective view to show the window blind of the present invention;

FIG. 3 shows that the slats are pivoted by the operation of the adjustment device, and

FIG. 4 shows that the slats are pivoted to another angular position by the operation of the adjustment device.

### DETAILED DESCRIPTION OF THE PREFERRED EMBODIMENT

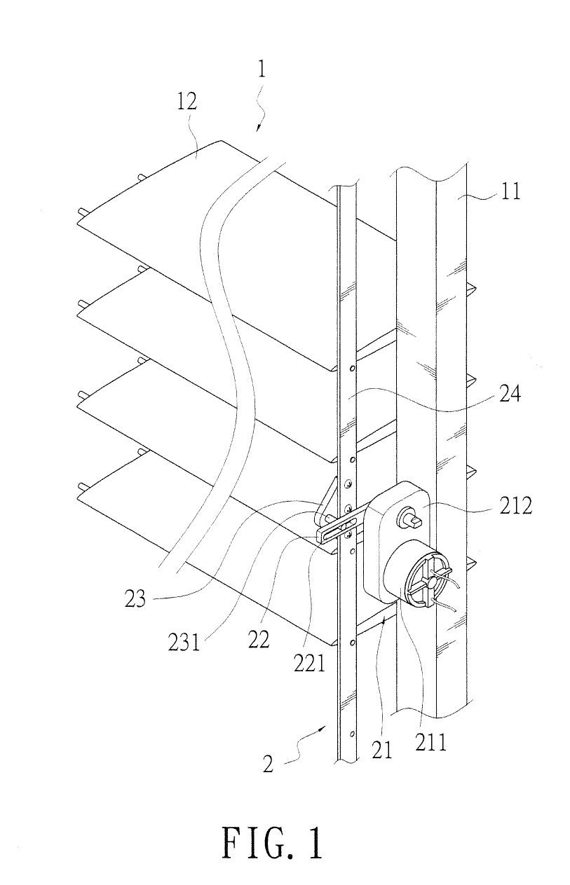

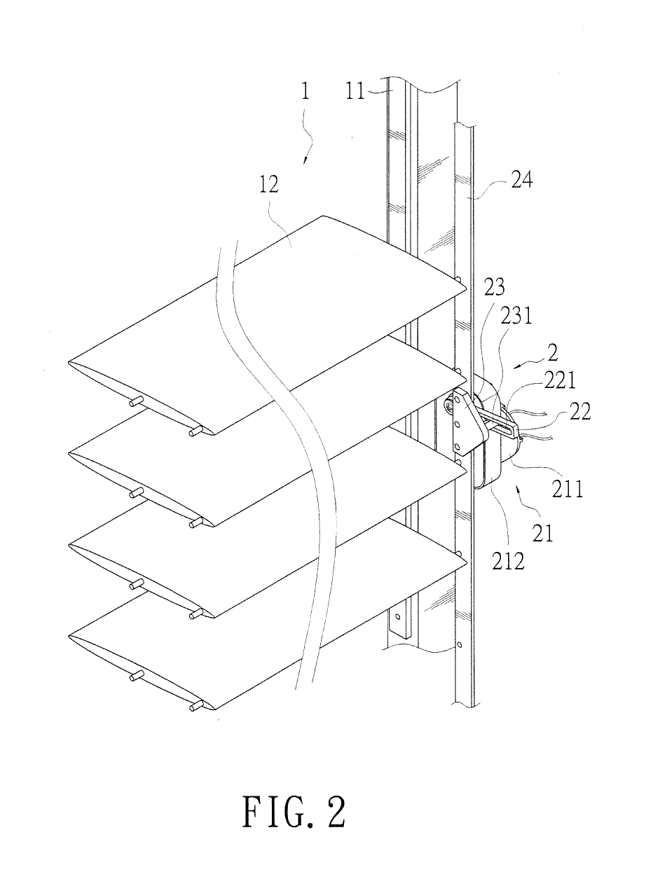

Referring to FIGS. 1 and 2, the window blind 1 of the present invention comprises a window frame 11 and multiple slats 12 are located between two side rails of the window frame 11. Each of the slats 12 has two end faces and each end face has a mediate portion and two end portions. The medial portion of each of two end faces of each of the slats 12 is pivotably connected to the window frame 11.

An adjustment device 2 is fixed to the window frame 11 and has a power unit 21 which has an output end, wherein the power unit 21 comprises a motor 211 and a gear reduction unit 212 connected to the motor 211 or a direct current motor. An arm 22 is connected to the output end and has an elongate slot 221. A link 23 is fixed to a plate 24 and has a protrusion 231 which is movably engaged with the elongate slot 221. One of the two end portions of each slat 12 is pivotably connected to the plate 24.

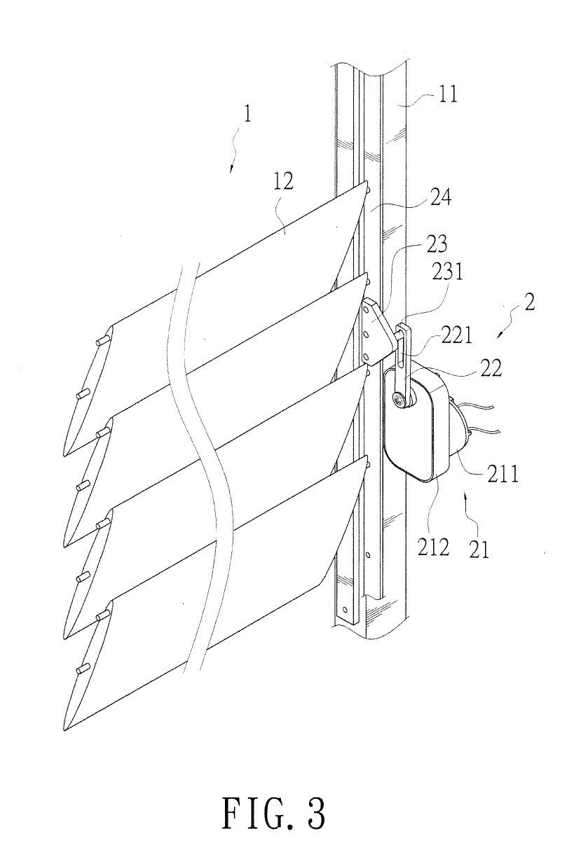

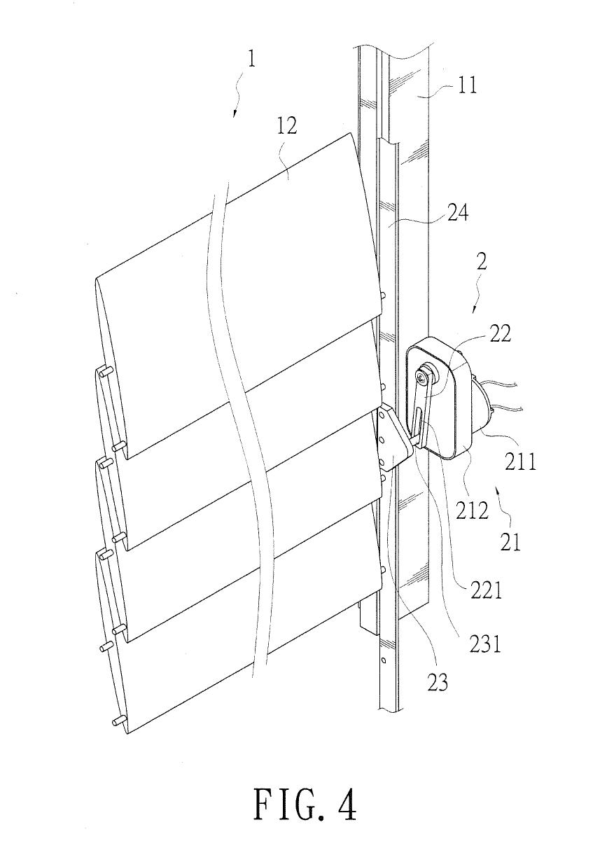

Further referring to FIGS. 3 and 4, when the power unit 21 of the adjustment device 2 is activated, the arm 22 is pivoted upward or downward by the power unit 21. Because the medial portion of each of the two end faces of each of the slats 12 is pivotably connected to the window frame 11, and one of the two end portions of each slat 12 is pivotably connected to the plate 24, so that when the arm 22 is pivoted, the link 23 is moved along with the movement of the protrusion 231 in the elongate slot 221 of the arm 22. Therefore, the plate 24 is moved upward or downward, and the slats 12 are pivoted and set at desired angular position to introduce light into the room.

Besides, the adjustment device 2 may have a remote control receiving unit which is connected with the power unit 21. The remote control receiving unit has a remote controller so that the users can operate the remote controller to send a command which is then received by the remote control receiving unit, and the power unit 21 is activated according to the command. By this way, the users do not need to approach the window blind 1 to operate the slats 12.

The window blind 1 uses the adjustment device 2 to control the operation of the slats 12 to pivot the slats 12 to partially open or close so as to introduce light or air into the room conveniently.

While we have shown and described the embodiment in accordance with the present invention, it should be clear to those skilled in the art that further embodiments may be made without departing from the scope of the present invention.

What is claimed is:

1. An electric window blind comprising:
a window frame and multiple slats located between two side rails of the window frame, each of the slats having two end faces and each end face having a mediate portion and two end portions, the medial portion of each of two end faces of each of the slats being pivotably connected to the window frame, and
an adjustment device having a power unit which has an output end, an arm connected to the output end and having an elongate slot, a link fixed to a plate and having a protrusion which is movably engaged with the elongate slot, one of the two end portions of each slat pivotably connected to the plate.

2. The window blind as claimed in claim 1, wherein the adjustment device is fixed to the window frame.

3. The window blind as claimed in claim 1, wherein the power unit comprises a motor and a gear reduction unit which is connected to the motor.

4. The window blind as claimed in claim 1, wherein the power unit is a direct current motor.

5. The window blind as claimed in claim 1, wherein the adjustment device has a remote control receiving unit which is connected with the power unit and has a remote controller.
